(19) United States
(12) Patent Application Publication
(10) Pub. No.: US 2006/0035001 A1
(43) Pub. Date: Feb. 16, 2006

(54) Phytonutrient oils

(76) Inventor: Artus L. Satterfield, Irvington, NJ (US)

Correspondence Address: ARTUS L. SATTERFIELD, 221 19th Ave., IRVINGTON, NJ, 07111, US

(21) Appl. No.: 10/919,462

(22) Filed: Aug. 16, 2004

(51) Int. Cl. A23D 9/00

(52) U.S. Cl. 426/601

(57) ABSTRACT

Oil soluble fractions of plants and plant products are extracted in vegetable oil over low heat and used to add flavor and nutrition to food.

### BACKGROUND—DESCRIPTION OF PRIOR ART

Animal fats and vegetable oils are required for many cooked foods.

### OBJECT AND OBJECTIVE

Phytonutrient oils are vegetable oils which contain oil soluble plant nutrients for added food value and taste.

### DESCRIPTION

Plants or plant products are placed in vegetable oil and heated over low flame to extract the oil soluble fractions. Tomatoes, turmeric, peppers and other plant materials produce tasty cooking oils for basting, grilling, frying and broiling.

### APPLICATION

Phytonutrient oils are added to mearts and and vegetable before and during the cooking process.

### SUMMARY, RAMIFICATIONS AND SCOPE

Canola oil and olive oil are the preferred oils for health promotion. Canola oil has a milder taste and aroma and is a better choice for that reason.

1. Vegetable oil for promoting health with phytonutrients.
